(19) United States
(12) Patent Application Publication
(10) Pub. No.: US 2008/0218500 A1
(43) Pub. Date: Sep. 11, 2008

(54) DISPLAY DRIVER

(76) Inventors: Akihito AKAI, Yokohama (JP); Yasuyuki Kudo, Fujisawa (JP); Kazuo Okado, Kokubunji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/023,379

(22) Filed: Jan. 31, 2008

(30) Foreign Application Priority Data
Mar. 9, 2007 (JP) 2007-059620

(51) Int. Cl. G09G 5/00

(52) U.S. Cl. 345/205

(57) ABSTRACT

A liquid crystal display device includes, in one of an even row and an odd row of a liquid crystal panel, a switch for short-circuiting, for example, an even signal line and an odd signal line adjacent on the left side to the even signal line, and a switch for short-circuiting the even signal line and an odd signal line adjacent on the right side to the even signal line provided at an output part of the signal-line driver. By controlling these switches, enlarged display equivalent to the bilinear processing is realized in a horizontal direction. By scanning two scanning lines simultaneously, simple enlarged display is realized in a vertical direction on the panel. Further, by stopping supply of a steady current to an operational amplifier applying data voltage to the even signal line, enlarged display at a low cost and at low power consumption is realized.

### CROSS-REFERENCE TO RELATED APPLICATION

The present application claims priority from Japanese Patent Application No. JP 2007-059620 filed on Mar. 9, 2007, the content of which is hereby incorporated by reference into this application.

### TECHNICAL FIELD OF THE INVENTION

The present invention relates to a display driver that generates a data voltage corresponding to display data to output the same to an active matrix type display panel, for example, a liquid crystal display panel, and a display device provided with the display driver. More particularly, the present invention relates to a technique effectively applied to a display driver capable of reducing power consumption especially for higher resolution of a display panel.

### BACKGROUND OF THE INVENTION

Recently, in a liquid crystal panel for mobile devices as typified by mobile phones, the liquid crystal panel advances to higher resolution. However, a resolution of horizontal 240×RGB and vertical 320 (hereinafter, it is called as “QVGA”) currently has been the mainstream in the display screen design of Internet contents and moving image contents for mobile phones, and it is considered that contents to be displayed will not be shifted to higher resolution immediately even if the display device advances to higher resolution. In accordance to this, Japanese Patent Application Laid-Open Publication No. 2004-252102 describes a method for performing an enlarging processing for converting to a display image corresponding to a resolution of a display device for displaying QVGA contents on the display device of higher resolution. However, to realize this method, it is necessary to provide an enlarging processing circuit and a display RAM corresponding to the display region, which results in increase of a load on an arithmetic processing unit or increase in cost.

And, display timing or an operation clock advances to higher frequency according to advance of a display device to higher resolution. Normally, power consumed in a panel or a driver is increased in proportion to the display timing or the operation clock, and thus power consumption tends to increase in a display of high resolution.

### SUMMARY OF THE INVENTION

When display data of QVGA is enlarged and displayed on a display panel of higher resolution than QVGA, for example, a display panel of a resolution of horizontal 480×RGB and vertical 640 (hereinafter, it is called as “VGA”) according to advance of a display to higher resolution, there is such a concern that cost increases due to the enlarging processing and power consumption increases in the enlarging method disclosed in Japanese Patent Application Laid-Open Publication No. 2004-252102.

Accordingly, in view of these circumstances, an object of the present invention is to provide a display driver capable of realizing a low-cost enlarging processing by utilizing a conventional circuit when display data having a resolution lower than a resolution of a display panel is displayed and further reducing power consumption of a display device.

The above and other objects and novel characteristics of the present invention will be apparent from the description of this specification and the accompanying drawings.

The typical ones of the inventions disclosed in this application will be briefly described as follows.

A display device according to the present invention mounts a display panel of high resolution and comprises a scanning line driver and a signal-line driver, in which a first switch for short-circuiting in one of an even row and an odd row of the display panel, for example, to an even signal line and a odd signal line adjacent on the left side of the even signal line, and a second switch for short-circuiting to the even signal line and an odd signal line adjacent on the right side of the even signal line are provided at an output part of the signal-line driver. The signal-line driver outputs a data voltage of the odd signal line to two signal lines of the odd signal line and the even signal line upon enlarged display by controlling the first switch and the second switch. Herein, as a combination of signal lines to be connected, the first switch is turned ON and the second switch is turned OFF in, for example, a first frame and a second frame so that the even signal line is connected to the odd signal line on the left side, and the first switch is turned OFF and the second switch is turned ON in a third frame and a fourth frame so that the even signal line is connected to the right side of the odd signal line. Thus, by performing switching of the data voltage applied to the even signal line for each frame, the even signal line displays the halftone of the odd signal lines adjacent to the left and right sides of the even signal line, so that enlarged display equivalent to a bilinear processing is realized in a horizontal direction. By scanning two scanning lines simultaneously, simple enlarged display is realized in a vertical direction of the panel.

In addition, low power consumption is realized upon the abovementioned enlarged display by stopping supplying of a steady current to an operational amplifier applying a data voltage to the even signal line.

According to such a configuration, a display driver can be provided which is capable of reducing cost and power consumption when image data having a resolution lower than that of a display device is displayed, as compared with the enlarging method described in Japanese Patent Application Laid-Open Publication No. 2004-252102.

Further, in terms of focusing on pixels on the display panel, when display is performed without changing a size of the display data, a display signal of the display data to be displayed on an odd row of pixels on the display panel is outputted to the odd row of pixels, and a display signal of the display data to be displayed on an even row of pixels on the display panel is outputted to the even row of pixels. When the size of the display data is changed and display is performed, a display signal of the display data to be displayed on one of the odd row and the even row of pixels on the display panel is outputted to both of the odd row and the even row of pixels adjacent to each other, and a combination of the odd row and the even row adjacent to each other is changed at a cycle of n frames (n is an integer equal to or larger than 2). According to such a configuration, a display driver that can realize an effect similar to the abovementioned one can be provided.

The effects obtained by typical aspects of the present invention will be briefly described below.

According to the present invention, when display data having a smaller resolution than that of a display panel is displayed in an enlarged manner, enlarged display equivalent to the bilinear processing can be made in a horizontal direction and a simple enlarged display can be made in a vertical direction on a panel. Here, by stopping supplying of a steady current to an operational amplifier that applies a data voltage to an even signal line, low power consumption can be realized in a display device. In this manner, since the present invention can be constructed by partial reconstruction of an existing signal-line driver, enlarged display is made possible in a display device without increasing cost and power consumption, and the present invention can be utilized effectively for a display device for mobile devices as typified by mobile phones.

### BRIEF DESCRIPTIONS OF THE DRAWINGS

FIG. 1 is a block diagram showing a configuration of a liquid crystal display device according to a first embodiment of the present invention;

FIG. 2 is a timing chart showing a voltage waveform applied to a liquid crystal panel and an operation timing of a switch upon an ordinary display where enlarged display is not performed of the liquid crystal display device according to the first embodiment of the present invention;

FIG. 3 is a timing chart showing a voltage waveform applied to a liquid crystal panel and an operation timing of the switch for performing an enlarged display in the liquid crystal display device according to the first embodiment of the present invention;

FIG. 4 is a diagram showing an arrangement (frames 4n, 4n+1) of display data on the liquid crystal panel when the enlarged display has been performed in the liquid crystal display device according to the first embodiment of the present invention;

FIG. 5 is a diagram showing an arrangement (frames 4n+2, 4n+3) of display data on the liquid crystal panel when the enlarged display has been performed in the liquid crystal display device according to the first embodiment of the present invention;

FIG. 6 is a timing chart showing a voltage waveform applied to a liquid crystal panel and an operation timing of a switch for performing an enlarged display in a liquid crystal display device according to a second embodiment of the present invention;

FIG. 7 is a diagram showing an arrangement (frames 4n, 4n+1) of display data on the liquid crystal panel when an enlarged display has been performed in the liquid crystal display device according to the second embodiment of the present invention;

FIG. 8 is a diagram showing arrangement (frames 4n+2, 4n+3) of display data on the liquid crystal panel when enlarged display has been conducted in the liquid crystal display device according to the second embodiment of the present invention;

FIG. 9 is a block diagram showing a configuration of a signal-line driver in a liquid crystal display device according to a third embodiment of the present invention;

FIG. 10 is a timing chart showing an operation timing of a switch for performing an enlarged display in the liquid crystal display device according to the third embodiment of the present invention;

FIG. 11 is a block diagram showing a configuration of a signal-line driver in a liquid crystal display device according to a fourth embodiment of the present invention; and

FIG. 12 is a timing chart showing an operation timing of a switch for performing an enlarged display in the liquid crystal display device according to the fourth embodiment of the present invention.

### DESCRIPTIONS OF THE PREFERRED EMBODIMENTS

While the present invention relates to a display device using an active matrix display panel, since it is considered that the most popular display panel widely prevalent among display panels is a liquid crystal display panel as described above, the liquid crystal panel is adopted as a typical example of a display panel and it will be explained in detail. Meanwhile, as described below, it is needless to say that the present invention is also applicable to the case where an active matrix display panel other than the liquid crystal panel, for example, a display panel of electroluminescence (EL) type.

Hereinafter, embodiments of the present invention will be described in detail with reference to the accompanying drawings. Note that components having the same function are denoted by the same reference symbols throughout the drawings for describing the embodiment, and the repetitive description thereof will be omitted.

### First Embodiment

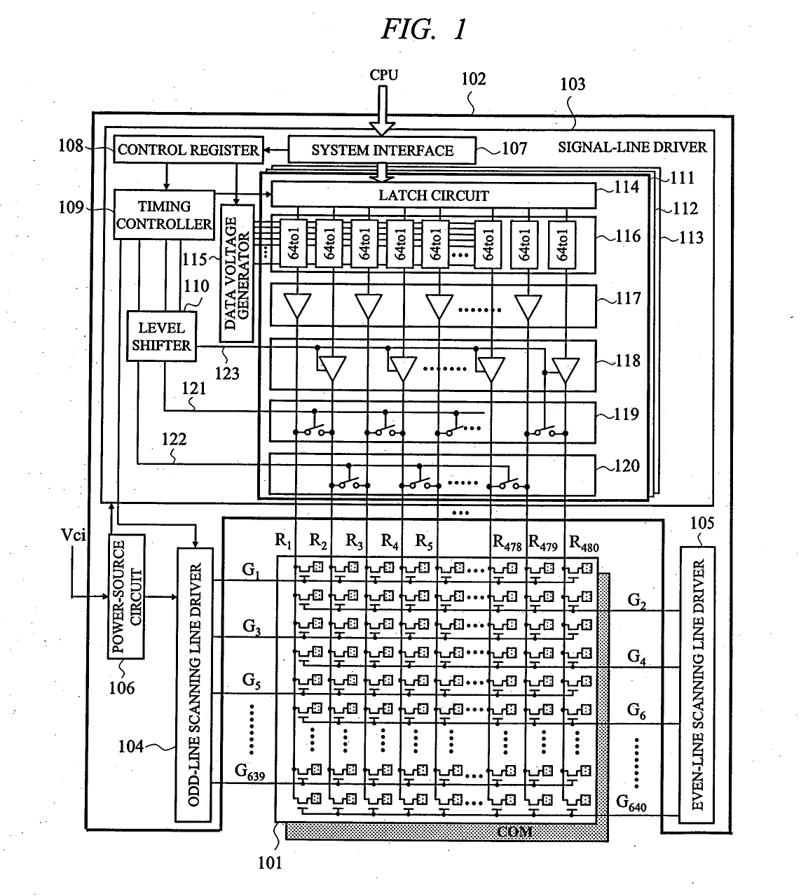

A configuration and an operation of a liquid crystal display device according to a first embodiment of the present invention will be described with reference to FIG. 1 to FIG. 5.

FIG. 1 is a block diagram showing a liquid crystal display device according to a first embodiment of the present invention. The liquid crystal display device according to the present embodiment comprises a liquid crystal panel 101 and a display driver 102 for driving the liquid display panel 101.

The liquid crystal panel 101 is configured as the active matrix type where a TFT is disposed for each pixel, and a signal line and a scanning line connected to the TFT are arranged in a matrix-like manner. Specifically, the liquid crystal panel 101 comprises: a plurality of signal lines (R₁ to R₄₈₀) arranged in a first direction; a plurality of scanning lines (G₁ to G₆₄₀) arranged in a second direction intersecting the first direction; a plurality of pixels provided corresponding to intersecting points of the plurality of signal lines and the plurality of scanning lines; and a switching element in each of the plurality of pixels having a first terminal coupled to a corresponding one of the plurality of signal lines, a second terminal coupled to a corresponding one of the plurality of scanning lines, and a third terminal coupled to a pixel electrode of the pixel.

The display driver 102 includes: a signal-line driver 103, an odd-line scanning line driver 104; an even-line scanning line driver 105; and a power source circuit 106, and it drives the liquid crystal panel 101 according to various data items transferred from a CPU.

The signal-line driver 103 converts display data transferred from the CPU to an analog data voltage to apply the converted data voltage to the pixel electrode connected to a source terminal of the TFT via the signal line in the liquid crystal display panel 101. Note that, according to the data voltage applied to the pixel electrode, an effective value thereof acting on a liquid crystal molecule is changed, thereby controlling the display luminance of the liquid crystal panel 101.

The odd-line scanning line driver 104 line-sequentially applies scanning pulses for putting TFTs in ON states to odd scanning lines in the liquid crystal panel 101. The even-line scanning line driver 105 line-sequentially applies scanning pulses for putting TFTs in ON states to the even scanning lines in the liquid crystal panel 101.

The power source circuit 106 is a block for generating power source voltage levels required in the signal-line driver 103, the odd-line scanning line driver 104 and the even-line scanning line driver 5 from a power source voltage Vci supplied externally. Note that, generation of the power source voltage levels can be realized by n-fold multiplying the power source voltage Vci by using a charge pump circuit and the like.

Next, a configuration of the signal-line driver 103 and operations of respective blocks configuring the signal-line driver 103 will be described.

The signal-line driver 103 comprises a system interface 107, a control register 108, a timing controller 109, a level shifter 110, a DAC (digital-analog conversion) circuit for R (Red) 111, a DAC circuit for G (green) 112, a DAC circuit for B (blue) 113, and a data voltage generator 115.

The system interface 107 receives display data and an instruction transferred from the CPU and performs an operation to output them to the control register 108. Here, the term “instruction” is information for determining internal operations of the signal-line driver 103 and the scanning line drivers 104 and 105, including various parameters such as a frame frequency, the number of drive lines, the number of colors, and an enlarged display setting DIS_M which is a feature of the present invention.

The control register 108 embeds a latch circuit and transfers the enlarged display setting DIS_M transferred from the system interface 107 to the timing controller 109 described below. Note that, the control register 108 includes an enlarged-display-setting register for holding the enlarged display setting DIS_M.

The timing controller 109 has a dot counter and generates a clock such as Hsync by counting dot clocks. And, based on the enlarged display setting DIS_M transferred from the control register 108, the timing controller 109 generates control signals SIG_L (121), SIG_R (122) of a switch 119 and a switch 120 and a control signal AMP_PW (123) for performing ON/OFF control on an even-signal-line operational amplifier 118, which will be described below.

The level shifter 110 converts control signals SIG_L (121), SIG_R (122), AMP_PW (123) transferred from the timing controller 109 from Vcc-GND level to VDD-GND level to transfer them to the switch 119, the switch 120, and the even-signal-line operational amplifier 118.

The DAC circuit for R 111 is a block for applying data a voltage defining the display luminance to a signal line of R: Rx in the liquid crystal panel 101, the DAC circuit for G 112 is a block for applying data voltage defining the display luminance to a signal line of G in the liquid crystal panel 101, and the DAC circuit for B 113 is a block for applying data voltage defining the display luminance to a signal line of B in the liquid crystal panel 101.

The DAC circuit for R 111 comprises a latch circuit 114, a 64-to-1 (64to1) selector 116, an odd-signal-line operational amplifier 117, the even-signal-line operational amplifier 118, the switch 119, and the switch 120. Note that, the internal configurations of the DAC circuit for R 111, the DAC circuit for G 112, and the DAC circuit for B 113 are identical.

The latch circuit 114 operates at the falling timing of a line clock and transfers display data items corresponding to one line to the 64to1 selector 116 all together.

The data voltage generating circuit 115 is a block for generating data voltage of 64 levels determining the display luminance of the liquid crystal panel 101, where, for example, VDD-GND power sources are connected by a ladder resistor and a data voltage generated according to a voltage division ratio of the ladder resistor is outputted to the 64to1 selector 116 described below. Note that, since the number of corresponding colors of the signal-line driver 103 is set to 6 bits in the present embodiment, the number of voltage levels to be outputted is 64 levels for each of R, G, and B. Meanwhile, the present invention is also applicable to the case where the number of corresponding colors is set to 8 bits. In this case, the data voltage generating circuit 115 generates 256 levels.

The 64to1 selector 116 converts digital display data transferred from the latch circuit 114 to an analog data voltage transferred from the data voltage generating circuit 115.

The odd-signal-line operational amplifier 117 buffers the analog data voltage corresponding to the odd signal line transferred from the 64to1 selector 116 and applies the data voltage to the odd signal line of the liquid crystal panel 101.

The even-signal-line operational amplifier 118 buffers the analog data voltage transferred from the 64to1 selector 116 and corresponding to the even signal line and applies the data voltage to the even signal line of the liquid crystal panel 101. Note that, the even-signal-line operational amplifier 118 performs switching between a supplying state and a supply-stopping state of a steady current according to the control signal AMP_PW (123) transferred from the level shifter 110 so that supply of a steady current to the even-signal-line operational amplifier 118 is performed at AMP_PW=1 (High) to output the data voltage transferred from the 64to1 selector 116 to a corresponding signal line. Supply of the steady current to the even-signal-line operational amplifier 118 is stopped at AMP_PW=0 (Low) and an output of the even-signal-line operational amplifier 118 is set to Hi-Z.

The switch 119 is a switching element which is controlled by the control signal SIG_L (121) transferred from the level shifter 110 and short-circuits an even signal line and an odd signal line adjacent on the left side (as viewing FIG. 1) thereto at, for example, SIG_L=1 (High), while opening the electric coupling between the even signal line and the odd signal line adjacent on the left side thereto at SIG_L=0 (Low).

The switch 120 is a switching element which is controlled by the control signal SIG_R (122) transferred from the level shifter 110 and short-circuits an even signal line and an odd signal line adjacent on the right side (as viewing FIG. 1) thereto at, for example, SIG_R=1 (High), while opening electric coupling between the even signal line and odd the odd signal line adjacent on the right side thereto at SIG_R=1 (Low). Note that, at the enlarged display setting DIS_M=1 (High), control is performed such that SIG_R=0 (Low) at SIG_L=1 (High) and SIG_R=1 (High) at SIG_L=0 (Low).

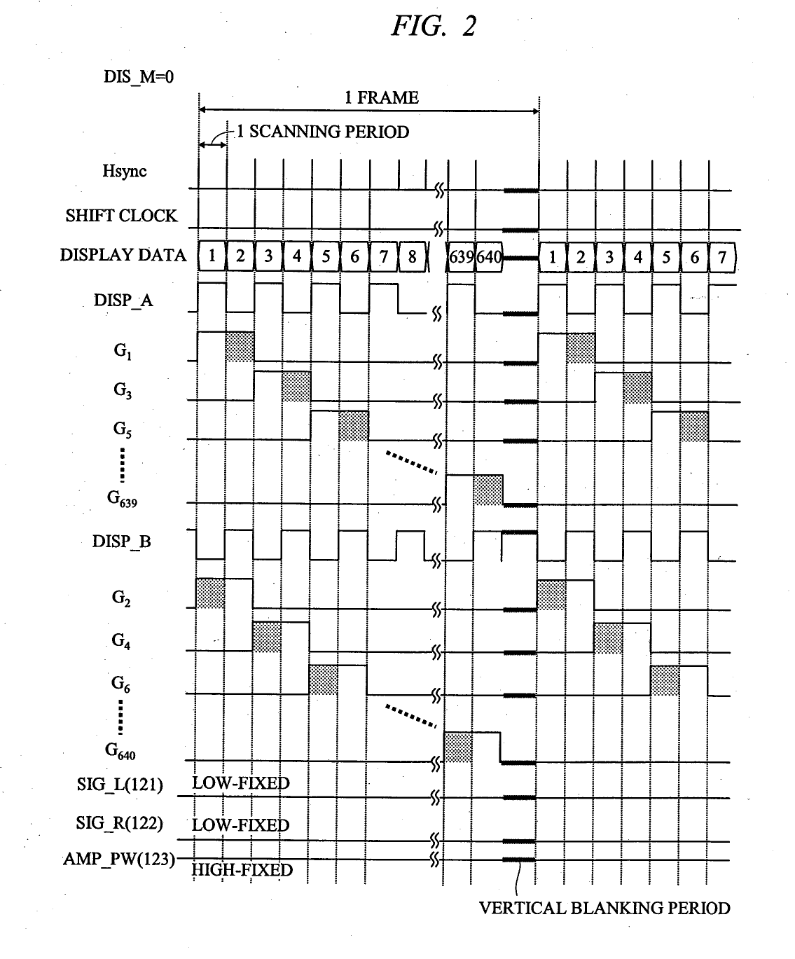

FIG. 2 is a timing chart regarding the signal-line driver 103, the odd-line scanning line driver 104, and the even-line scanning line driver 105 when the resolution of the liquid crystal panel 101 is identical with the resolution of display data at the enlarged display setting DIS_M=0 (Low). FIG. 2 shows, with reference to the period signal Hsync, a relationship among an output timing of the data voltage from the signal-line driver 103, shift clocks from the odd-line scanning line driver 104 and the even-line scanning line driver 105, and an output scanning pulse.

The signal-line driver 103 transfers the data voltage to the liquid crystal panel 101 by horizontal one line in synchronization with Hsync. Shift clocks of the odd-line scanning line driver 104 and the even-line scanning line driver 105 are set to two scanning periods, and a mask signal DISP_A of the odd-line scanning line driver 104 is a mask timing for enabling the odd lines of the scanning lines. In this manner, the odd-line scanning line driver 104 outputs a signal for scanning the odd line by a shift operation for each two scanning periods. In addition, a mask signal DISP_B of the even-line scanning line driver 105 is a mask timing for enabling the even lines of the scanning lines, and the even-line scanning line driver 105 outputs a signal for scanning the even line by a shift operation for each two scanning periods.

In the enlarged display setting DIS_M=0 (Low), the control signal SIG_L (121) and control signal SIG_R (122) are 0 (Low) fixed, while a control signal AMP_PW (123) is 1 (High) fixed.

According to the above control, scanning pulses by which scanning lines G₁ to G₆₄₀ are line-sequentially selected can be generated, and the signal-line driver 103 can perform ordinary display of resolution VGA, more specifically, can display display data which is identical with the resolution of the display device since the odd-signal-line operational amplifier 117 and the even-signal-line operational amplifier 118 apply a data voltage transferred from the 64to1 selector 116 to a corresponding signal line. In other words, the signal-line driver 103 can perform display on the liquid display panel 101 without changing the size of the display data by outputting a display signal of the display data to be displayed to an odd row of the pixels of the liquid crystal panel 101 to the odd row of pixels of the liquid crystal panel 101 and outputting a display signal of display data to be displayed to an even row of pixels of the liquid crystal panel 101 to the even row of pixels of the liquid crystal panel 101.

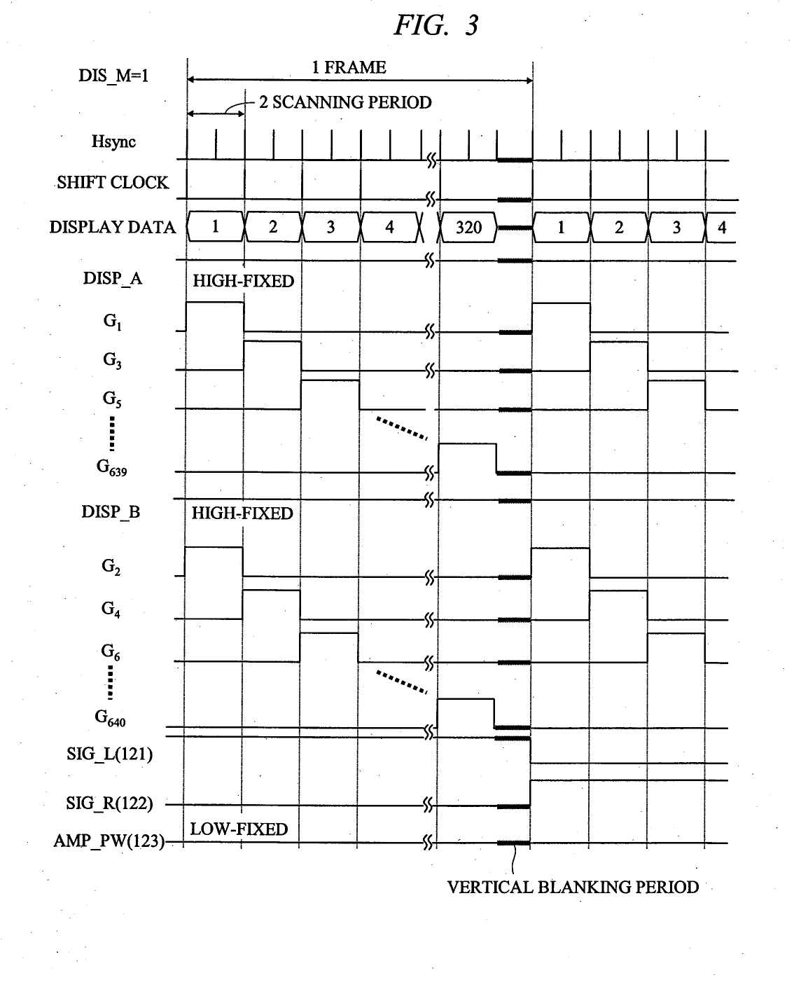

FIG. 3 shows a timing chart when display data is displayed on the liquid crystal panel 101 of resolution VGA at the enlarged display setting DIS_M=1 (High) by doubling display data of QVGA which is a mainstream resolution of contents for mobile phones in a horizontal direction and a vertical direction, and FIG. 3 shows, with reference to the horizontal period signal Hsync, a relationship among output timing of the data voltage from the signal-line driver 103, shift clocks from the odd-signal line scanning line driver 104 and the even-signal line scanning line driver 105, and an output scanning pulse.

The signal-line driver 103 outputs the data voltage from the display data of resolution QVGA to be inputted while performing switching for each two scanning periods. The shift clocks of the scanning line drivers 104 and 105 are set to two scanning periods, and mask signals DISP_A and DISP_B are High-fixed so that a mask is released. Thereby, for example, scanning pulses selecting 2 lines, such as G₁ and G₂, G₃ and G₄, . . . , G₆₃₉ and G₆₄₀ through simultaneous scanning can be generated.

Note that, the control signal SIG_L (121) is switched between 0 (Low) and 1 (High) for each two frames at the enlarged display setting DIS_M=1 (High). The control signal SIG_R (122) is set such that it operates with a phase opposite to that of the SIG_L (121), for example, setting is performed such that SIG_R (122)=1 (High) at SIG_L (121)=0 (Low) and SIG_R (122)=0 (Low) at SIG_L(121)=1 (High). The signal AMP_PW (123) to control ON/OFF of the odd-signal-line operational amplifier 118 is 0 (Low)-fixed.

According to this control, supply of a steady current to the odd-signal-line operational amplifier 118 is stopped, so that switching is performed between the state where the even-signal line short-circuits to the odd-signal line on the left side and the state where the even-signal line short-circuits to the odd-signal line on the right side for each two frames.

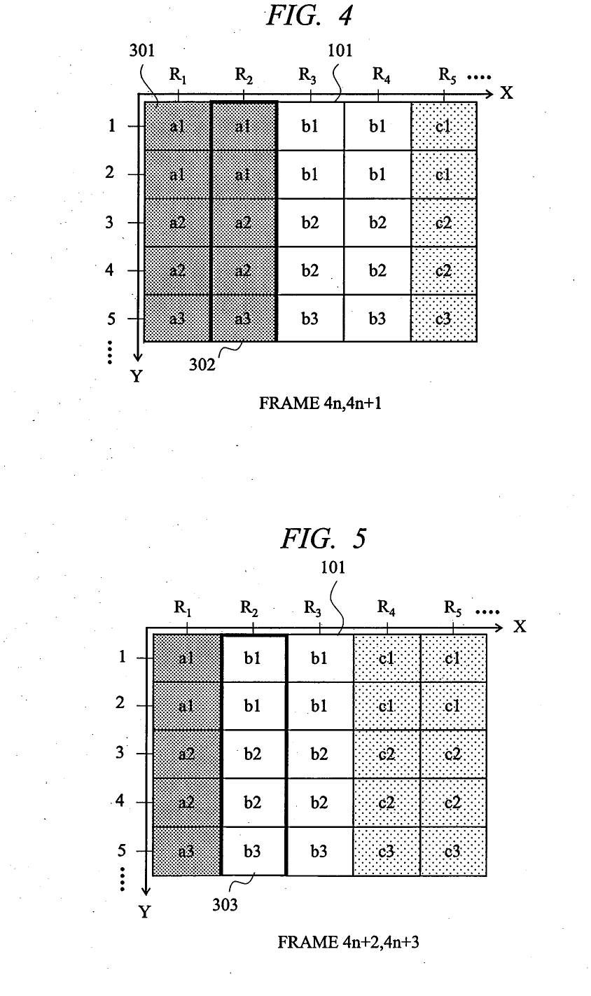

FIG. 4 and FIG. 5 show arrangements of display data on the liquid crystal panel 101 to which the present embodiment is applied (DIS_M=1 (High)), FIG. 4 shows an arrangement of display data on the liquid crystal panel 101 for frames 4n and 4n+1, and FIG. 5 shows an arrangement of display data on the liquid crystal panel 101 for frames 4n+2 and 4n+3. The reference numeral 301 denotes the display data, the alphabets denote the x-coordinate of the display data (a, b, c, . . . ), and the numbers denote the y-coordinate of the display data. As explained previously, since the scanning pulses selecting two lines according to simultaneous scanning are applied at DIS_M=1 (High), data items arranged on coordinates (X, Y)=(R₁, 1) and (R₁, 2) on the liquid crystal panel 101 become the same data a1 and data items arranged on coordinates (X, Y)=(R₁, 3) and (R₁, 4) become the same data a2. In this manner, simple enlarged display is made possible in a horizontal direction.

The reference numeral 302 denotes display data on an even signal line R₂ for frames 4n and 4n+1, the reference numeral 303 denotes display data on the even-signal line R₂ for frames 4n+2 and 4n+3. Focusing on a coordinate (X, Y)=(R₂, 1) on the liquid crystal panel 101, the data of the coordinate becomes the same data a1 as the data on (X, Y)=(R₁, 1) adjacent thereto on the left side regarding the frames 4n and 4n+1, and the data on the coordinate becomes the same data b1 as the data on (X, Y)=(R₃, 1) adjacent thereto on the right side regarding the frames 4n+2 and 4n+3. By switching data items for each two frames in this manner, the luminance of (X, Y)=(R₁, 1) and the luminance of (X, Y)=(R₃, 1) are alternately displayed on the coordinate (X, Y)=(R₂, 1) on the liquid crystal panel 101, so that intermediate luminance display according to time modulation is realized. As a result, enlarged display equivalent to bilinear processing can be made in a horizontal direction.

According to the above-described control, simple enlarged display in the vertical direction is made possible and enlarged display equivalent to bilinear processing in the horizontal direction is made possible. In other words, a display signal of display data to be displayed on one of an odd row and an even row of pixels of the liquid crystal panel 101 is outputted to both adjacent odd row and even row of pixels of the liquid crystal panel 101. Further, by changing a combination of an odd row and an even row adjacent to each other for each two frames, display data changed in size can be displayed on the liquid crystal panel 101.

Note that, when alternation of the driving voltage is essential like the liquid crystal panel 101, as described above, it is necessary to perform switching between signal levels of SIG_L (121) and SIG_R (122) for each two frames to make the operation at a cycle of four frames. For example, when switching between signal levels of SIG_L (121) and SIG_R (122) is performed for each one frame, switching of the data voltage applied to the even-signal line and polarity change of the applied voltage occur at the same timing. As a result, when the polarity of the application voltage is positive, a data voltage of an adjacent signal line always on the left side is applied, and when the polarity is negative, a data voltage of an adjacent signal line always on the right side is applied, and so it causes image retention of liquid crystal molecule. In the present embodiment, therefore, the operation of the four-frame cycle where switching between signal levels of SIG_L (121) and SIG_R (122) is performed for each two frames has been described, but switching between SIG_L (121) and SIG_R (122) is performed for each one frame to perform an operation at a two-frame cycle on a display panel which does not require alternation of driving voltage, for example, that of organic EL.

Note that, while it has been described that an operation at a four-frame cycle is required when the present invention is applied to a liquid crystal panel, it is possible to improve the frame frequency to shorten the frequency. In the case of the enlarged display setting DIS_M=1 (High), the scanning line drivers 104 and 105 output scanning pulses for simultaneous scanning whose width of High is a two-scanning period. If the frame frequency is doubled, the width of High of the scanning pulse is reduced to ½ of time but it becomes equal to a one-scanning period which is a width of High of a scanning pulse at the enlarged display setting DIS_M=0 (Low). Accordingly, such a configuration that the frame frequency is changed so as to be identical with the enlarged display setting DIS_M may be adopted.

According to the circuit configuration and the operation timing as described above, when the resolution of the liquid crystal panel 101 coincides with the resolution of display data, normal display of same magnification is performed as making the enlarged display setting DIS_M=0 (Low), and when display data smaller than the resolution of the liquid crystal panel 101 is displayed in an enlarged manner, enlarged display equivalent to bilinear processing is performed in a horizontal direction and simple enlarged display is performed in a vertical direction as the enlarged display setting DIS_M=1 (High), so that lower power consumption can be realized in the display device.

Further, when switching of the enlarged display setting DIS_M is performed from the CPU, switching between the normal mode for displaying display data of resolution VGA to the liquid crystal panel 101 of, for example, resolution VGA and the enlarged display mode for displaying display data of resolution QVGA to the liquid crystal panel 101 of resolution VGA in an enlarged manner can be performed easily. Still further, switching of the enlarged display setting DIS_M can be performed based on automatic determination of the resolution instead of a register value inputted from the CPU.

Note that, while an example where the display data smaller than the resolution of the liquid crystal panel 101 is displayed in an enlarged manner has been described above, when the resolution of the liquid crystal panel 101 coincides with the resolution of display data, the present embodiment can be applied also to a case where display data is thinned out in the horizontal direction and in the vertical direction in every two lines in order to reduce power consumption of the display device for display. In this case, for example, when the display data has the resolution VGA, the display data in the horizontal direction includes data corresponding to 640 lines, display data of the display data transferred from the CPU which corresponds to the pixel electrodes connected to the even scanning lines G₂, G₄, G₆, . . . , G₆₄₀ are thinned out and only display data thereof which corresponds to pixel electrodes connected to odd scanning lines G₁, G₃, G₅, . . . , G₆₃₉ is transferred to the display driver 102. On that basis, when the enlarged display setting DIS_M=1 (High) is set, the enlarged display which is the feature of the present embodiment can be realized and the steady current of the even-signal-line operational amplifier 118 can be reduced to 0, so that low power consumption of the display driver 102 can be realized. Since complementary display equivalent to bilinear processing in a horizontal direction can be made by control of the switch 119 and the switch 120 described in the present embodiment, and image quality degradation can be made minimal even if display is performed thinning display data. Note that, when the signal-line driver 103 has a built-in display RAM for retaining the display data transferred from the CPU, it is unnecessary to thin out the display data on the CPU and the abovementioned display can be performed easily by changing a method for reading data from the display RAM.

The present invention is an active matrix type panel sharing signal lines in a vertical direction or in a horizontal direction, and it can be applied to any panel if it controls display luminance by voltage levels. In the present embodiment, while the case that the resolution of the display panel is VGA and the resolution of display data is QVGA has been described as an example, the resolution may be CIF (352RGB×288), QCIF (176RGB×144), and other resolutions. Further, while the case where the scanning line driver comprises two systems of the odd-line scanning line driver 104 and the even-line scanning line driver 105 has been described, the present invention can be applied to one system or more than two systems if an operation similar to the above is made. While the case that the signal-line driver 103 does not include a built-in display RAM has been described as an example, the present invention can be applied to the signal-line driver 103 with a built-in display RAM. In the present embodiment, while the case where the signal-line driver 103, the scanning line drivers 104, 105, and the power source circuit 106 are built in the display driver 102 has been described as an example, the scanning line driver 104, 105 may be built in the liquid crystal panel 101 or the power source circuit 106 may be built in the liquid crystal panel 101 as long as the operation similar to the control content described above can be realized.

### Second Embodiment

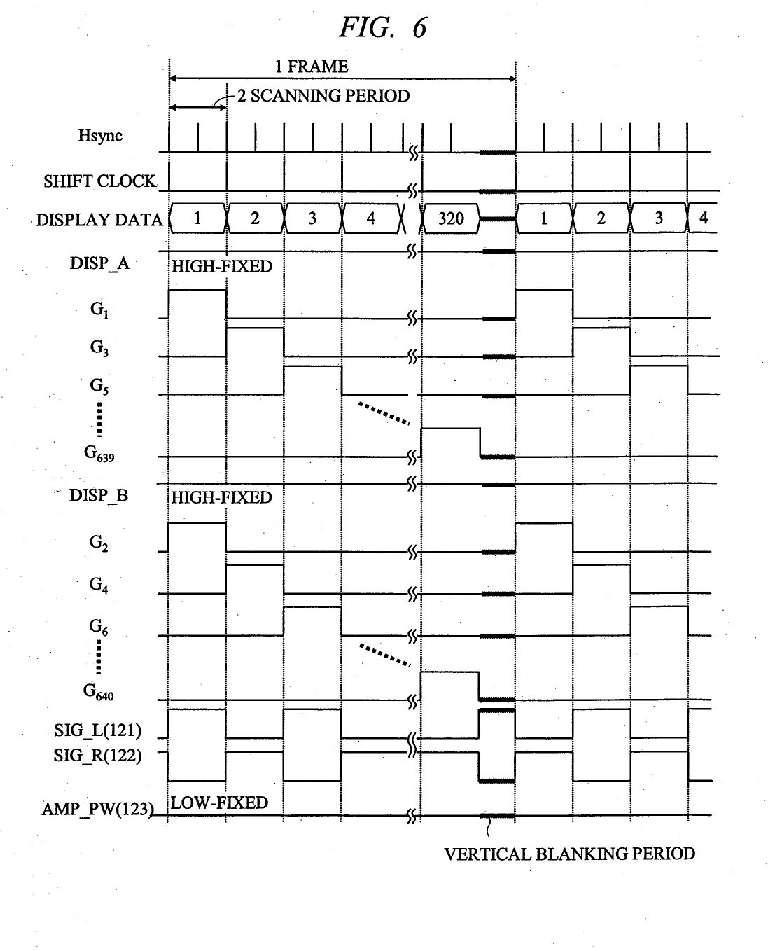

A configuration and an operation of a liquid crystal display device according to a second embodiment of the present invention will be described with reference to FIG. 6 to FIG. 8.

In the second embodiment of the present invention, regarding a data voltage applied to even signal lines upon enlarged display, a cycle for performing switching between a data voltage of an odd signal line adjacent on the left side and a data voltage of an odd signal line adjacent on the right side is set to a two-scanning period so that luminance changes of the odd signal lines do not become the same at a unit of a vertical line, and even when a difference in luminance between the luminance of the odd signal line adjacent on the left side and the luminance of the odd signal line adjacent on the right side is large, the change is prevented from being perceived as flickering.

FIG. 6 is a timing chart according to the second embodiment of the present invention, where operations of the signal SIG_L (121) controlling the switch 119 and the signal SIG_R (122) controlling the switch 120 configure a feature part of the present embodiment. Note that, the other parts of this embodiment are similar to those of the first embodiment, and descriptions thereof will be omitted hereinafter.

The operations of SIG_L (121) and SIG_R (122) are similar to those of the first embodiment of the present invention in case of the enlarged display setting DIS_M=0 (Low). As shown in FIG. 6, in case of the enlarged display setting DIS_M=1 (High), switching between SIG_L (121)=0 (Low) and SIG_L (121)=1 (High) is performed for each two scanning periods. Note that, SIG_R (122) is operated to have a phase opposite to that of SIG_L (121) like the first embodiment of the present invention, as SIG_R (122)=1 (High) in case of SIG_L (121)=0 (Low) and SIG_R (122)=0 (Low) in case of SIG_L (121)=1 (High).

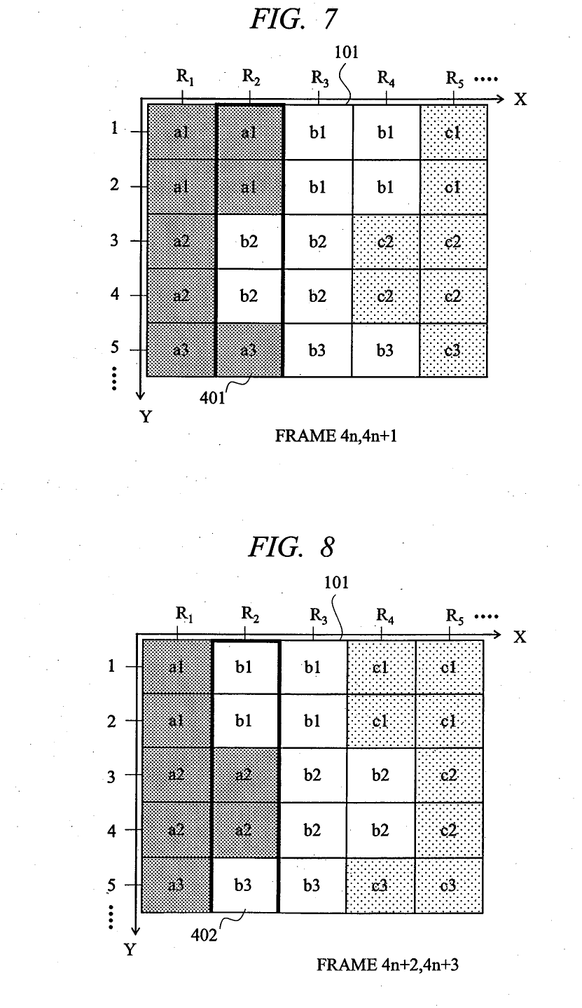

FIG. 7 and FIG. 8 show arrangements of display data on the liquid crystal panel 101 to which the present embodiment is applied (DIS_M=1 (High)), FIG. 7 shows an arrangement of display data on the liquid crystal panel 101 of frames 4n and 4n+1, and FIG. 8 shows an arrangement of display data on the liquid crystal panel 101 of frames 4n+2 and 4n+3. The reference numeral 401 denotes display data of an even signal line R₂ of frames 4n and 4n+1, while the reference numeral 402 denotes display data of an even signal line R₂ of frames 4n+2 and 4n+3. Focusing on the display data 401, data of coordinates (X, Y)=(R₂, 1), (R₂, 2) on the liquid crystal panel 101 becomes the same data a1 as coordinates (X, Y)=(R₁, 1), (R₁, 2) adjacent on the left side thereto, and data of coordinates (X, Y)=(R₃, 3), (R₃, 4) of the liquid crystal panel 101 becomes the same data b2 as coordinates (X, Y)=(R₃, 3), (R₃, 4) adjacent on the right side thereto. In this manner, the display data 401 of the even signal line R₂ takes a comb-shaped arrangement of data voltages of adjacent signal lines. Focusing on the display data 402, data of coordinates (X, Y)=(R₂, 1), (R₂, 2) of the liquid crystal panel 101 becomes the same date b1 as coordinates (X, Y)=(R₃, 1), (R₃, 2) adjacent on the right side thereto, and data of coordinates (X, Y)=(R₂, 3), (R₂, 4) on the liquid crystal panel 101 becomes the same data a2 as coordinates (X, Y)=(R₁, 3), (R₁, 4) adjacent on the left side thereto. In this manner, the display data 402 of the even signal line R₂ takes a comb-shaped arrangement different from that of the display data 401. By performing switching between the display data 401 and the display data 402 for each two frames, the luminance of (X, Y)=(R₁, 1) and luminance of (X, Y)=(R₃, 1) are alternately displayed on the coordinate (X, Y)=(R₂, 1) of the liquid crystal panel 101, so that intermediate luminance display according to time modulation can be realized.

According to the circuit configuration and the operation timing described above, enlarged display and lower power consumption of the display device can be realized by the drive method for applying a corresponding data voltage to an odd signal line adjacent to an even signal line described in the first embodiment of the present invention. Since the arrangement of data voltages becomes comb-shaped and the data voltages applied to the odd-signal lines are not same for a unit of a vertical line, which are the features of the present invention, perception of luminance change for each two frames can be made difficult.

### Third Embodiment

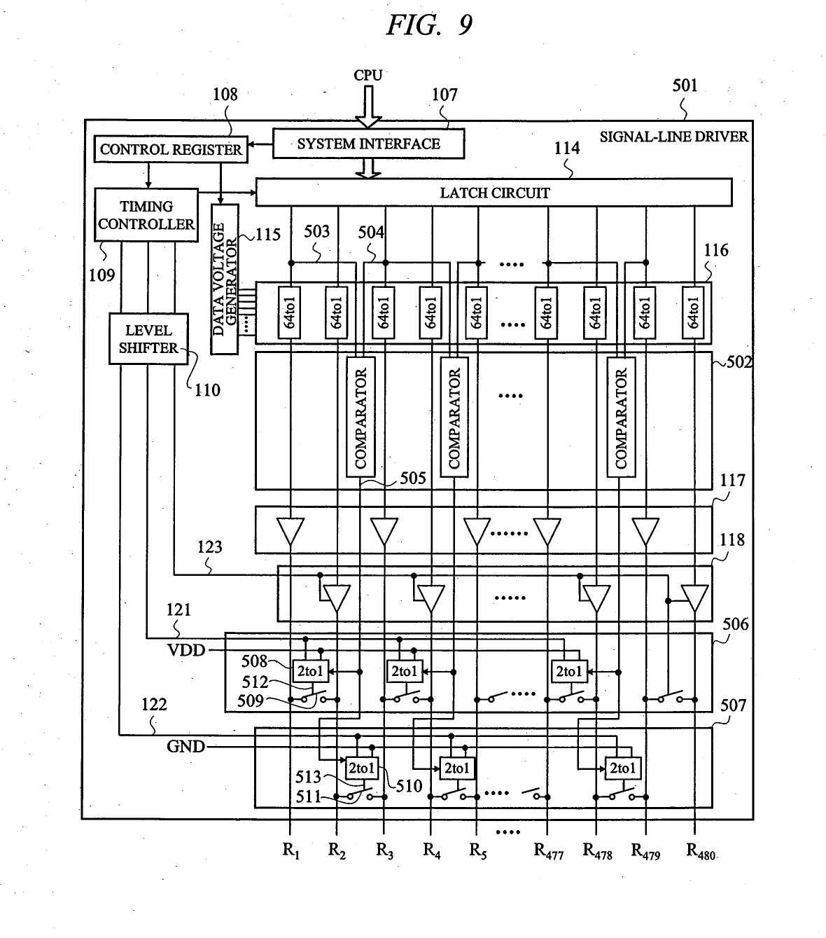

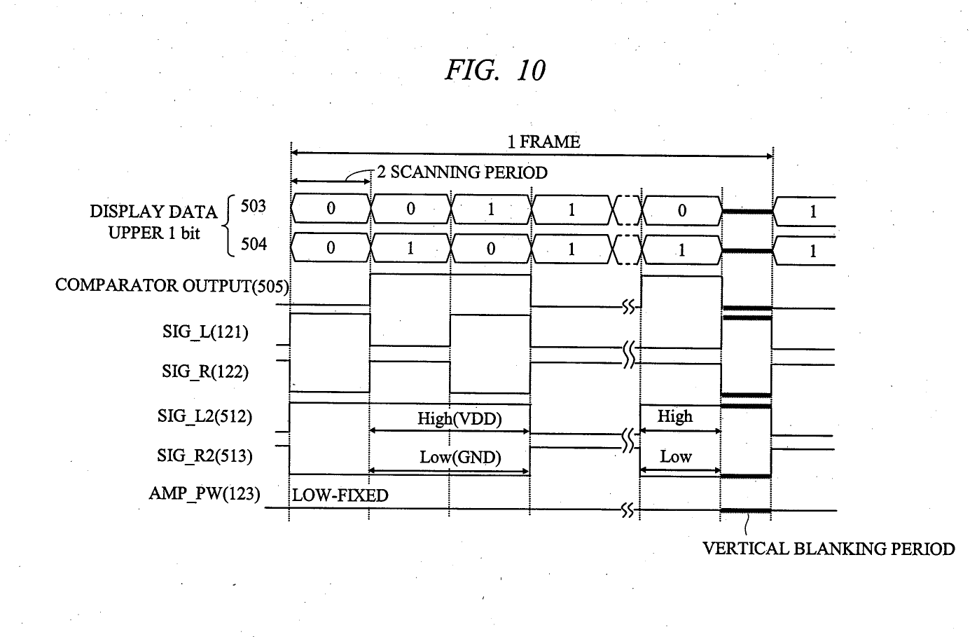

A configuration and an operation of a liquid crystal display device according to a third embodiment of the present invention will be explained with reference to FIG. 9 and FIG. 10.

The third embodiment of the present invention is configured such that display data items corresponding to two odd signal lines sandwiching an even signal line are compared with each other, and when a difference between the data is large, signal levels of control signals SIG_L (121) and SIG_R (122) of switching operations partially described in the first and second embodiments are fixed so that simple enlarged display is performed also in a horizontal direction.

FIG. 9 is a block diagram of a signal-line driver according to the third embodiment of the present invention, where the reference numeral 501 denotes a signal-line driver, 502 denotes a comparator, 503 and 504 denote upper 1-bit display data corresponding to an odd-signal line, 505 denotes operation result of the comparator 502, 506 denotes a switch unit, 507 denotes a switch unit, 508 denotes a 2-to-1 (2to1) selector, 509 denotes a switch, 510 denotes a 2to1 selector, 511 denotes a switch, 512 denotes a control signal SIG_L2 which is an output of the 2to1 selector 508, and 513 denotes a control signal SIG_R2 which is an output of the 2to1 selector 510. The comparator 502, the switch unit 506, and the switch unit 507 configure feature parts of the present embodiment. Note that, the other parts of this embodiment are similar to those of the first and second embodiments, and thus description thereof will be omitted hereinafter.

The comparator 502 gets inputs of display data items corresponding to two kinds of odd signal lines transferred from the latch circuit 114, for example, upper 1-bit display data (503, 504) corresponding to a signal line R₁ and a signal line R₃ to perform an operation of exclusive OR. The operation result 505 is transferred to the switch unit 506 and the switch unit 507.

The switch unit 506 comprises the 2to1 selector 508 and the switch 509 for short-circuiting an even signal line and an odd signal line adjacent on the left side to the even line, and the switch unit 506 gets inputs of the SIG_L (121) transferred from the level shifter 110, a power source voltage VDD inputted from the power source circuit 106 and the operation result 505 transferred from the comparator 502.

The 2to1 selector 508 selects one of 2 levels of SIG_L (121) transferred from the level shifter 110 and a power source voltage VDD inputted from the power source circuit 106 based on the operation result 505 transferred from the comparator 502. Note that, when the operation result 505 is 1 (High), the 2to1 selector 508 selects the power source voltage VDD level, and when the operation result 505 is 0 (Low), the 2to1 selector 508 selects SIG_L (121). And, the control signal SIG_L2 (512) which is an output of the 2to1 selector 508 is transferred to the switch 509.

The switch 509 short-circuits an even signal line and an odd signal line adjacent on the left side thereto when the abovementioned output signal 512 is 1 (High (VDD level)), and the switch 509 opens the electric coupling of the even signal line and the odd signal line adjacent on the left side thereto when the output signal 512 is 0 (Low).

The switch unit 507 comprises the 2to1 selector 510 and the switch 511 for short-circuiting an even signal line and an odd signal line adjacent on the right side thereto, and the switch unit 507 gets an input of SIG_R (122) transferred from the level shifter 110, GND level and the operation result 505 transferred from the comparator 502.

The 2to1 selector 510 selects one of two levels of SIG_R (122) and GND level transferred from the level shifter 110 based on the operation result 505 transferred from the comparator 502. Note that, when the operation result 505 is 1 (High), the 2to1 selector 510 selects GND level, and when the operation result 505 is 0 (Low), the 2to1 selector 510 selects SIG_R (122). The control signal SIG_R2 (513) which is an output of the 2to1 selector 510 is transferred to the switch 511.

The switch 511 short-circuits an even signal line and an odd signal line adjacent on the left side thereto when the abovementioned output signal 513 is 1 (High), and it opens electric coupling of the even signal line and the odd signal line adjacent on the left side thereto when the output signal 513 is 0 (Low (GND level)).

FIG. 10 is a timing chart for realizing the present embodiment, showing a relationship among display data, SIG_L (121) and SIG_R (122) transferred from the level shifter 110, the output signal SIG_L2 (512) of the 2to1 selector 508, the output signal SIG_R2 (513) of the 2to1 selector 510, and the ON/OFF control signal AMP_PW (123) of the even-signal-line operational amplifier 118.

When values of the upper 1 bit (503) and upper 1 bit (504) of the display data are different from each other, the comparator 502 determines that a difference in luminance between the signal line R1 and the signal line R3 is large and outputs 1 (High) to fix SIG_L2 (512) and SIG_R2 (513) to 1 (High) and 0 (Low), respectively, regardless of values of SIG_L (121) and SIG_R (122) transferred from the level shifter 110. According to this control, an enlarged display method, for example, switching between an enlarged display equivalent to bilinear processing and simple enlarged display can be made according to the display data.

Note that, a plurality of comparators 502 are provided for each two odd signal lines, and they can operate independently. Accordingly, such a case arises that operations of the switch 509 and the switch 511 are different from each other for each even signal line depending on the display data, which results in that enlarged display equivalent to bilinear processing and simple enlarged display are present within the liquid crystal panel 101 in a mixed manner. However, such a configuration may be adopted that operations of the switch unit 506 and the switch unit 507 can be made identical for each one line or for every one or more frames in the horizontal direction based on a plurality of operation results 505 transferred from the plurality of comparators 502.

And, the present embodiment can be realized by adding the comparator 502 to the first or second embodiment of the present invention and modifying the switch unit 506 and the switch unit 507, and if the operation result 505 of the comparator 502 is fixed to 0 (Low) by a set value inputted externally, switching between the present embodiment and the first and second embodiments can be made easily.

According to the circuit configuration and the operation timing described above, enlarged display and low power consumption of a display device are realized by the driving method for applying a corresponding data voltage to an odd signal line adjacent to an even signal line, which has described in the first and second embodiments of the present invention, and enlarged display equivalent to bilinear processing and simple enlarged display can be switched to display according to the display data, which is the feature of the present invention. In this manner, even if a difference of display luminance between two odd signal lines adjacent to an even signal line is large, perception of luminance change for each two frames can be made difficult.

Note that, in the present embodiment, while the case where an upper 1 bit of the display data corresponding to an odd signal line referred to by the comparator 502 is inputted into the comparator 502 has been described, since only detection of a luminance difference between targeted signal lines is required, for example, upper 2 bits or more of display data may be used instead of the upper 1 bit.

### Fourth Embodiment

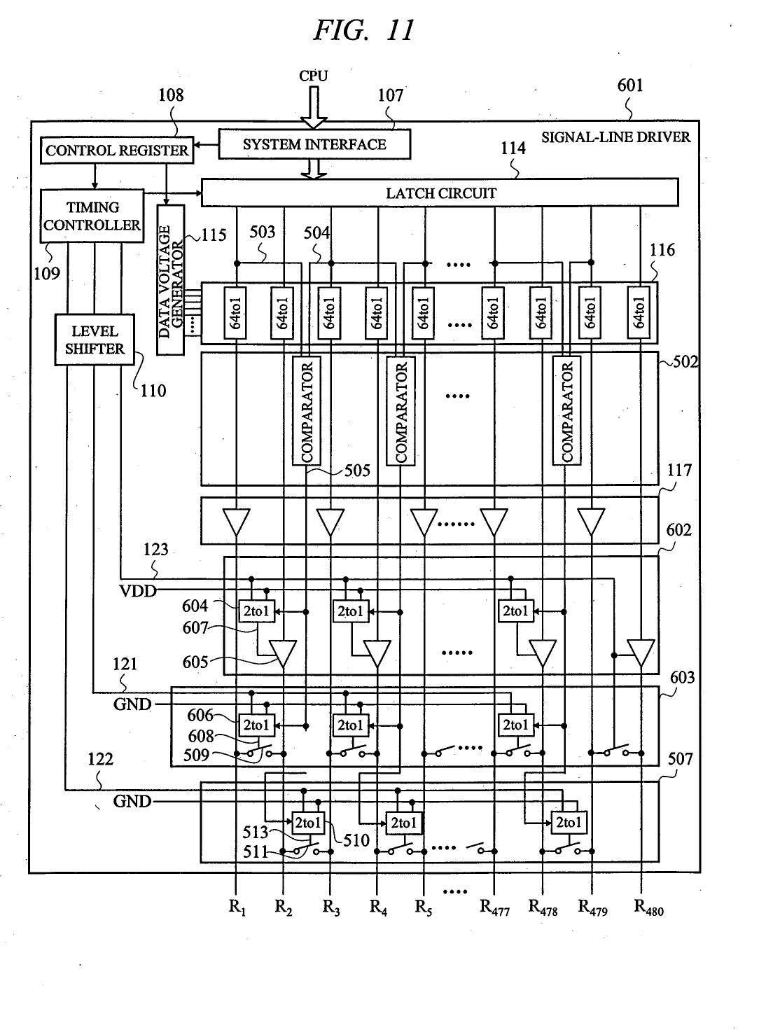

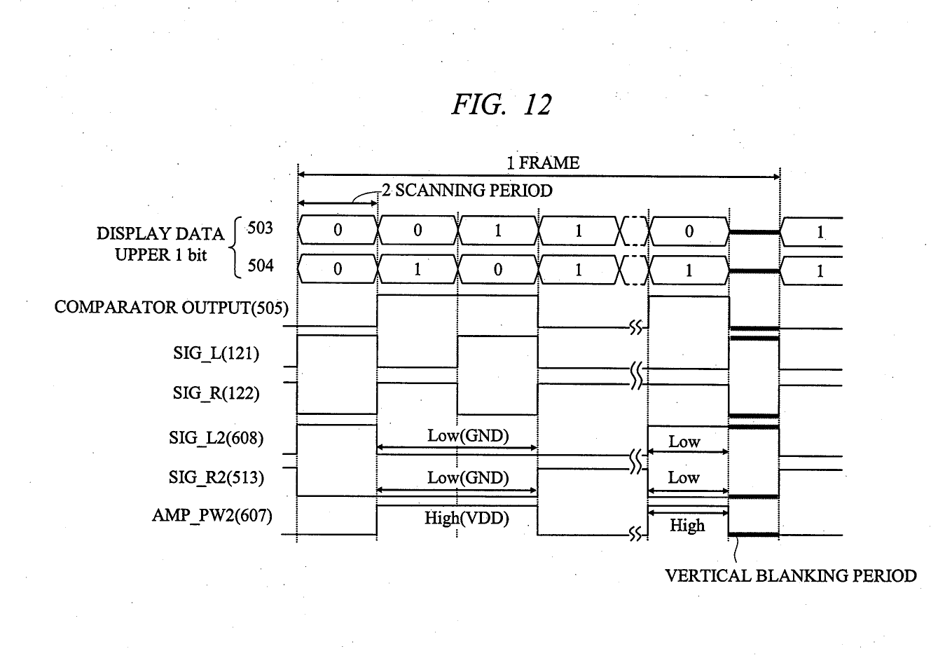

A configuration and an operation of a liquid crystal display device according to a fourth embodiment of the present invention will be described with reference to FIG. 11 and FIG. 12.

The fourth embodiment of the present invention is configured such that, on the premise that the resolution of the liquid crystal panel 101 and the resolution of display data are identical with each other, display data items corresponding to two odd signal lines sandwiching an even signal line are compared with each other, and when a difference between the data items are large, the data voltage transferred from the 64to1 selector 116 is applied to a signal line by an even-signal-line operational amplifier unit 602 without performing switching operation described in the first and second embodiments partially. In this manner, normal same magnification display is performed regarding a case where a luminance difference between two odd signal lines adjacent to an even signal line is large, while enlarged (interpolated) display described in the first and second embodiments is performed regarding a case where a luminance difference of the signal line between two odd signal lines adjacent to an even signal line is small. Consequently, when the resolution of the liquid crystal panel 101 and the resolution of display data are identical with each other, even if the display data is thinned out to be displayed aiming reduction of power consumption, image quality degradation can be made minimal.

FIG. 11 is a block diagram of a signal-line driver according to the fourth embodiment of the present invention, in which the reference numeral 601 denotes a signal-line driver, 602 denotes the even-signal-line operational amplifier unit, 603 denotes a switch unit, 604 denotes a 2to1 selector, 605 denotes an operational amplifier, 606 denotes a 2to1 selector, 607 denotes a control signal AMP_PW2, 608 denotes a control signal SIG_L2, and the even-signal-line operational amplifier 602 is a feature part of the present invention. Note that, the other parts of this embodiment are similar to those of the first to third embodiments of the present invention, and explanations thereof will be omitted hereinafter.

The even-signal-line operational amplifier unit 602 comprises the 2to1 selector 604 and the operational amplifier 605, and gets an input of the operation result 505 transferred from the comparator 502.

The 2to1 selector 604 selects one of the control signal AMP_PW (123) transferred from the level shifter 110 and a the lower source voltage level VDD inputted from the power source circuit 106 based upon the operation result 505 transferred from the comparator 502. Note that, when the operation result 505 is 1 (High), the 2to1 selector 604 selects the power source voltage level VDD, and when the operation result 505 is 0 (Low), the 2to1 selector 604 selects AMP_PW (123). The control signal AMP_PW2 (607) which is an output of the 2to1 selector 604 is transferred to the operational amplifier 605.

The operational amplifier 605 buffers an analog data voltage corresponding to an even signal line transferred from the 64to1 selector 116 and applies the data voltage to the even signal line of the liquid crystal panel 101. Note that, setting is made such that switching between a supplying state of a steady current to the operational amplifier 605 and a supplying-stop state thereof can be performed according to the control signal AMP_PW2 (607) transferred from the 2to1 selector 604, so that a steady current is supplied to the operational amplifier 605 and the data voltage transferred from the 64to1 selector 116 is outputted to a corresponding signal line at AMP_PW2=1 (High). At AMP_PW2=0 (Low), supply of the steady current to the operational amplifier 605 is stopped so that the output thereof becomes Hi-Z.

The switch unit 603 comprises the 2to1 selector 606 and a switch 509 short-circuiting an even signal line and an odd signal line adjacent on the left side to the even signal line, and the 2to1 selector 606 gets inputs of SIG_L (121) transferred from the level shifter 110, GND level and the operation result 505 transferred from the comparator 502.

The 2to1 selector 606 selects one of two levels of SIG_L (121) transferred from the level shifter 110 and GND level based on the operation result 505 transferred from the comparator 502. Note that, when the operation result 505 is 1 (High), the 2to1 selector 606 selects the GND level, and when the operation result 505 is 0 (Low), the 2to1 selector 606 selects the SIG_L (121). And then, the control signal SIG_L2 (608) which is an output of the 2to1 selector 606 is transferred to the switch 509.

The switch 509 short-circuits an even signal line and an odd signal line adjacent on the left side to the even signal line when the control signal SIG_L2 (608) transferred from the 2to1 selector 606 is 1 (High), and the switch 509 opens the electric coupling of the even signal line and the odd signal line adjacent on the left side to the even signal line when the control signal SIG_L2 (608) is 0 (Low (GND level)).

FIG. 12 is a timing chart for realizing the present embodiment, showing a relationship among display data, SIG_L (121) and SIG_R (122) transferred from the level shifter 110, the control signal SIG_L2 (608) which is an output of the 2to1 selector 606, the control signal SIG_R2 (513) which is an output of the 2to1 selector 510 and the control signal AMP_PW2 (607) which is an output of the 2to1 selector 604.

When a difference between values of upper 1 bit (503) and upper 1 bit of (504) of display data are different from each other, the comparator 502 determines that a luminance difference between the signal line R₁ and the signal line R₃ is large and outputs 1 (High) to fix SIG_L2 (608) and SIG_R2 (513) to 0 (Low) regardless of values of SIG_L (121) and SIG_R (122) transferred from the level shifter 110. In this manner, since the electric coupling of the even signal line with the odd signal line adjacent thereto is opened and AMP_PW2 (607) becomes 1 (High), a steady current is supplied to the operational amplifier 605, so that the operational amplifier 605 applies the data voltage transferred from the 64to1 selector 116 to a corresponding signal line. According to this control, switching between normal same magnification display and enlarged display according to the display data can be made.

Note that, a plurality of comparators 502 are provided for each two odd signal lines, and they can operate independently. Accordingly, such a case arises that operations of the switch 509 and the switch 511 are different from each other for each even signal line depending on the display data, which results in that enlarged display equivalent to bilinear processing and simple enlarged display are present within the liquid crystal panel 101 in a mixed manner. However, such a configuration may be adopted that operations of the switch unit 506 and the switch unit 507 can be made identical for each one line or every one or more frames in a horizontal direction.

The present embodiment can be realized by adding the comparator 502 to the first or second embodiment of the present invention and modifying the even-signal-line operational amplifier 602, the switch unit 603 and the switch unit 507, and if the operation result 505 of the comparator 502 is fixed to 0 (Low) by a set value inputted externally, switching between the present embodiment and the first and second embodiments can be made easily.

According to the circuit configuration and the operation timing as described above, enlarged display and low power consumption of the display device are realized by the driving method for applying a corresponding data voltage corresponding to an odd signal line adjacent to an even signal line, which has described in the first and second embodiments of the present invention, and when a difference in display luminance between two odd signal lines sandwiching an even signal line is large, the electric coupling between signal lines adjacent to each other is opened, so that a data voltage to a corresponding even signal line is applied by the operational amplifier 605. In this manner, even if a difference in display luminance between two adjacent odd signal lines adjacent to an even signal line is large, perception of luminance change for each two frames can be made difficult.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention can realize enlarged display at a low cost and at low power when display data having a smaller resolution than that of a display panel is displayed in an enlarged manner. And, regarding the applicable range, the present invention is also applicable to not only a display for a mobile phone but also other mobile terminals having a liquid crystal display.

What is claimed is:

1. A display driver for driving a display panel comprising:
a plurality of signal lines arranged in a first direction; a plurality of scanning lines arranged in a second direction intersecting the first direction; a plurality of pixels provided corresponding to intersecting points of the plurality of signal lines and the plurality of scanning lines; and a switching element which is provided corresponding to each of the plurality of pixels and has a first terminal coupled to a corresponding one of the plurality of signal lines, a second terminal coupled to a corresponding one of the plurality of scanning lines, and a third terminal coupled to a pixel electrode of the pixel, the display driver comprising:
a scanning line driver which line-sequentially outputs scanning pulses showing a selecting state to the scanning lines for each one scanning period; and
a signal-line driver which outputs data voltages corresponding to display data to the signal lines,
wherein the signal-line driver comprises:
a circuit for applying a data voltage to the signal line;
a switching element for opening and closing a first electric coupling provided between a first signal line of one of an even row and an odd row of the display panel and a second signal line adjacent on the left side to the first signal line; and
a switching element for opening and closing a second electric coupling provided between the first signal line and a third signal line adjacent on the right side to the first signal line, and
wherein the signal-line driver comprises:
a first method of applying a data voltage for opening the first electric coupling and opening the second electric coupling to apply data voltages corresponding to the signal lines to respective signal lines; and
a second method of applying a data voltage for performing switching between a first electric coupling state where the first electric coupling is closed and the second electric coupling is opened to apply a data voltage corresponding to the second signal line to the first signal line and a second electric coupling state where the first electric coupling is opened and the second electric coupling is closed to apply a data voltage corresponding to the third signal line to the first signal line.

2. The display driver according to claim 1,
wherein, in the first method of applying a data voltage, the scanning line driver outputs a scanning pulse to one scanning line per one scanning period, and
in the second data applying method, the scanning line driver outputs a scanning pulse to at one or more scanning lines per one scanning period.

3. The display driver according to claim 2,
wherein, in the second method of applying a data voltage, supply of a steady current to the circuit for applying a data voltage that applies a data voltage to the first signal line is stopped so that an output of the circuit for applying a data voltage is changed to a Hi-Z state.

4. The display driver according to claim 3,
wherein a change between the first method of applying a data voltage and the second method of applying a data voltage is performed according to a register value inputted from an external device or an automatic determination of resolution.

5. The display driver according to claim 4,
wherein, when a switching between the first method of applying a data voltage and the second method of applying a data voltage is performed, the signal line driver and the scanning line driver can change a frame frequency for driving the display panel.

6. The display driver according to claim 5,
wherein a change of the frame frequency is performed according to a register value inputted from an external device or an automatic determination of resolution.

7. The display driver according to claim 6,
wherein, in the second method of applying a data voltage, a cycle of performing a switching between the first electric coupling state and the second electric coupling state is two or more scanning periods.

8. The display driver according to claim 7,
wherein, in the second method of applying a data voltage, the cycle of performing a switching between the first electric coupling state and the second electric coupling state can be changed by a register value inputted from an external device.

9. The display driver according to claim 8,
wherein, a change between the first method of applying a data voltage and the second method of applying a data voltage is performed according to a comparison result between display data on the second signal line and display data on the third signal line.

10. The display driver according to claim 9,
wherein the display data on the second signal line and the display data on the third signal line is upper 1 bit or more.

11. A display driver for driving a display panel comprising: a plurality of signal lines arranged in a first direction; a plurality of scanning lines arranged in a second direction intersecting the first direction; a plurality of pixels provided corresponding to intersecting points of the plurality of signal lines and the plurality of scanning lines; and a switching element which is provided corresponding to each of the plurality of pixels and has a first terminal coupled to a corresponding one of the plurality of signal lines, a second terminal coupled to a corresponding one of the plurality of scanning lines, and a third terminal coupled to a pixel electrode of the pixel, the display driver comprising:
a scanning line driver which line-sequentially outputs scanning pulses showing a selecting state to the scanning lines for each one scanning period; and
a signal-line driver which outputs data voltages corresponding to display data to the signal lines,
wherein the signal-line driver comprises:
a circuit for applying a data voltage to the signal line;
a switching element for opening and closing a first electric coupling provided between a first signal line of one of an even row and an odd row of the display panel and a second signal line adjacent on the left side to the first signal line; and
a switching element for opening and closing a second electric coupling provided between the first signal line and a third signal line adjacent on the right side to the first signal line, and
wherein the signal-line driver comprises:
a first method of applying a data voltage for opening the first electric coupling and opening the second electric coupling to apply data voltages corresponding to the signal lines to respective signal lines;
a second method of applying a data voltage for performing switching between a first electric coupling state where the first electric coupling is closed and the second electric coupling is opened to apply a data voltage corresponding to the second signal line to the first signal line and a second electric coupling state where the first electric coupling is opened and the second electric coupling is closed to apply a data voltage corresponding to the third signal line to the first signal line; and
a third method of applying a data voltage for closing the first electric coupling and opening the second electric coupling to apply a data voltage corresponding to the second signal line to the first signal line.

12. The display driver according to claim 11,
wherein, in the first method of applying a data voltage, the scanning-line driver outputs a scanning pulse to one scanning line per one scanning period, and
in the second method of applying a data voltage and the third method of applying a data voltage, the scanning line driver outputs a scanning pulse to one or more scanning lines per one scanning period.

13. The display driver according to claim 12,
wherein, in the second method of applying a data voltage and the third method of applying a data voltage, supply of a steady current to the circuit for applying a data voltage to the first signal line is stopped so that an output of the data voltage applying circuit is changed to a Hi-Z state.

14. The display driver according to claim 13,
wherein a change between the first method of applying a data voltage and the second method of applying a data voltage or the third method of applying a data voltage is performed according to a register value inputted from an external device or an automatic determination of resolution.

15. The display driver according to claim 14,
wherein, in the second method of applying a data voltage, a cycle of performing a switching between the first electric coupling state and the second electric coupling state is two or more scanning periods.

16. The display driver according to claim 15,
wherein, in the second method of applying a data voltage, the cycle of performing a switching between the first electric coupling state and the second electric coupling state can be changed by a register value inputted from the external device.

17. The display driver according to claim 16,
wherein a change between the second method of applying a data voltage and the third method of applying a data voltage is performed according to a comparison result between display data of the second signal line and display data of the third signal line.

18. The display driver according to claim 17,
wherein the display data of the second signal line and the display data of the third signal line are upper 1 bit or more.

19. A display driver for changing a size of inputted display data to display the display data on a display panel having pixels arranged in a matrix shape, the display driver performing:
when display data is displayed on the display panel without changing the size of the display data, output of a display signal of display data to be displayed on an odd row of the pixels of the display panel to the odd row of the pixels on the display panel and output of a display signal of display data to be displayed on an even row of pixels on the display panel to the even row of pixels of the display panel;
when the display data is displayed on the display panel with changing the size of display data, output of a display signal of display data to be displayed on one of an odd row and an even row of the pixels of the display panel to both the odd row and the even row of pixels of the display panel adjacent to each other; and
when the display data is displayed on the display panel with changing the size of display data, a change of a combination of the odd row and the even row adjacent to each other to which the display signal of display data to be displayed on one of the odd row and the even row is outputted, at each n-frames cycle (n is an integer equal to or larger than 2).

20. A display driver for changing a size of inputted display data to display the display data on a display panel having pixels arranged in a matrix shape, the display driver performing:
output of a display signal of the display data to each pixel via a signal line connected to each pixel; and
when the display data is displayed on the display panel with changing the size of the display data, connection of two adjacent signal lines to output a display signal of display data to be displayed on one of an odd row and an even row of the pixels of the display panel to both the odd row and the even row of pixels of the display panel adjacent to each other.
